(19) United States
(12) Patent Application Publication
(10) Pub. No.: US 2014/0118810 A1
(43) Pub. Date: May 1, 2014

(54) MODULAR AIRCRAFT WINDOW WITH MULTIPLE LIGHT CONTROL ELEMENTS

(71) Applicant: MSA Aircraft Products, Ltd., San Antonio, TX (US)

(72) Inventor: Nicholas C. Mohat, San Antonio, TX (US)

(21) Appl. No.: 14/065,007

(22) Filed: Oct. 28, 2013

Related U.S. Application Data
(60) Provisional application No. 61/718,802, filed on Oct. 26, 2012.

(51) Int. Cl. G02F 1/1333

(52) U.S. Cl. CPC G02F 1/133377
USPC 359/238

(57) ABSTRACT

Various systems and techniques may be used to provide light control in modular aircraft window assemblies. In particular implementations, a modular aircraft window assembly may include a frame having an opening and a substantially transparent exterior lens attached to the frame and covering the opening thereof The window assembly may also have at least a first smart window element. In particular implementations, the first smart window element may be segmented into portions that may be individually controlled. In certain implementations, the window assembly may additionally have a second smart window element. In some implementations, the first smart window element may be adapted to maintain substantial transparency while allowing variable light transmittance responsive to a first input signal, and the second smart window element may be adapted to alternate between substantial transparency and substantial translucency responsive to a second input signal.

### RELATED APPLICATIONS

This application claims priority to U.S. Provisional Application No. 61/718,802, entitled “Modular Aircraft Window with Multiple Smart Light Control Elements” and filed on Oct. 26, 2012. The provisional application is herein incorporated by reference in its entirety.

### FIELD OF THE INVENTION

This application relates to modular windows for aircraft, and, in particular, to modular aircraft windows with light control.

### BACKGROUND OF THE INVENTION

Modular windows are used in aircraft to provide natural lighting to the interior thereof. “Modular” as used herein means a single, unitary structure that needs only to be attached to an aircraft interior. Such modular windows typically contain a frame, an exterior lens, or pane, and a light control system. A reveal, an interior lens, and an overlay panel may also be incorporated into modular aircraft windows.

The function of a modular aircraft window's light control system is to regulate the amount of light entering the interior of the aircraft. Aircraft windows employ a variety of techniques and materials to control the amount of exterior light permitted into the aircraft interior, including movable mechanical barriers (whose movement may or may not be electronically controlled) and fixed materials with variable transmittance responsive to control stimuli.

For example, U.S. Pat. No. 4,679,610 (Spraggins) discloses a modular window with a collapsible, mechanical shade. Likewise, U.S. Pat. No. 6,230,784 (Sanz et al.) discloses a modular window with an electronically controlled mechanical shade. Published U.S. patent application Ser. No. 12/384,318 (Mohat et al.) discloses another type of modular window with an electronically controlled mechanical shade.

It is also well known in the art to use materials with variable transmittance for light control. These materials are typically affixed to or integrated with a plastic (or glass) lens to create a light control element. The prior art discloses multiple methods of using electrical input (typically voltage), thermal input, or optical input to control and vary the amount of light transmission through a material. These technologies are commonly referred to as smart windows, switchable glass, privacy glass, light valves, electrochromic devices, suspended particle devices (SPD), micro-blinds, or polymer dispersed liquid crystals (PDLC) devices, but are collectively identified as “smart windows” hereinafter.

For example, U.S. Pat. No. 7,333,258 (Yang et al.), U.S. Pat. No. 7,375,871 (Libretto et al.), and U.S. Pat. No. 7,710,671 (Kwak et al.) all disclose and discuss different types of smart window technologies. Published U.S. patent application Ser. No. 12/420,151 (Mohat et al.) discloses a modular window for an aircraft having an SPD smart window and an opaque, mechanical shade.

The different types of smart windows change light transmittance in very different ways. For example, SPDs may gradually (i.e., over seconds or minutes) vary the level of transmittance while maintaining transparency. Other smart windows, such as PDLC devices, may rapidly alternate between transparency and translucency (i.e., increased light diffusion) in milliseconds. The transmittance characteristics and the length of time required to vary the transmittance characteristics depends on a number of factors, including the type and size of the smart window.

### SUMMARY

In certain general implementations, multiple smart window elements (or segments thereof) are incorporated in a modular aircraft window assembly for improved light control.

In particular embodiments, a modular aircraft window assembly may include a first smart window element that is capable of maintaining substantial transparency but allowing variable transmittance (i.e., for tinting purposes) and a second smart window element that is capable of alternating between transparency and translucency (i.e., for privacy purposes).

In some embodiments, a modular aircraft window assembly may include a controllable, segmented smart window element. This provides an aesthetically pleasing light control system.

Other features will be readily observable to those of ordinary skill in the art from the following description and claims, as well as the accompanying drawings

### DESCRIPTION OF THE DRAWINGS

FIG. 1 is an exploded perspective view of a prior art modular aircraft window with a shade assembly.

FIG. 2 is an exploded perspective view of an example lens with multiple light control elements.

FIG. 3 is a schematic drawing of an example rectangular lens with multiple light control elements.

FIG. 4 shows the rectangular lens with sequential linear activation of the light control elements.

FIG. 5 is a schematic drawing of an example circular lens with multiple light control elements.

FIG. 6 shows the circular lens with sequential circular activation of the multiple light control elements.

FIG. 7 is a schematic drawing of another example circular lens with multiple light control elements.

FIG. 8 shows the second circular window with sequential circular activation of the with multiple light control elements.

FIG. 9 is a block diagram illustrating selected components of an example controller for a modular aircraft window with multiple light control elements.

### DETAILED DESCRIPTION

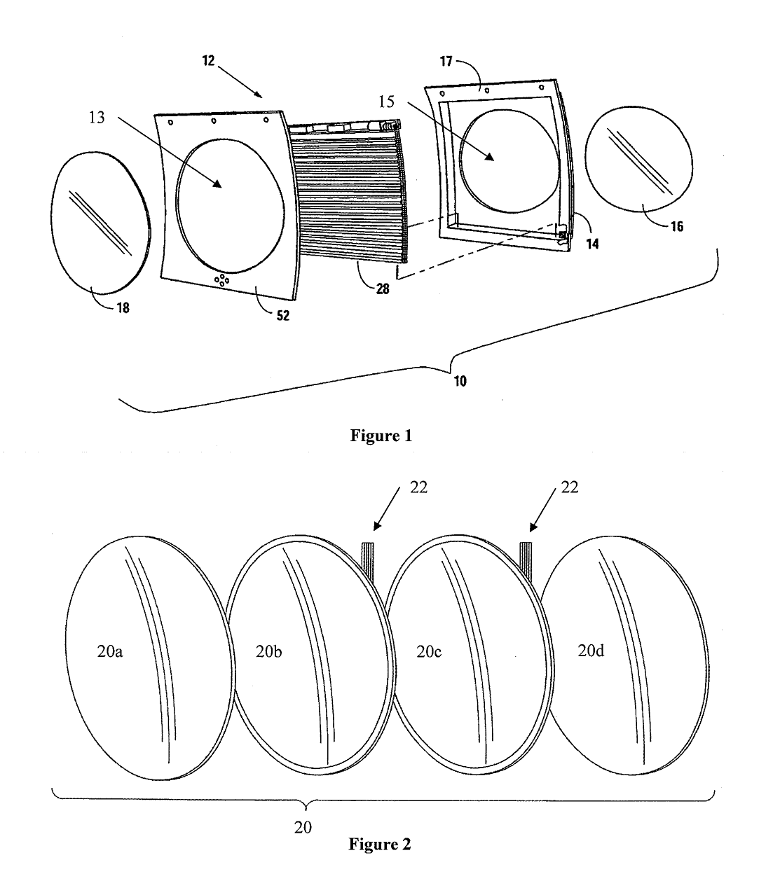

FIG. 1 illustrates a typical prior art modular window assembly 10 that includes an interior lens 18, an overlay panel 52, a shade assembly 12 with a mechanical shade 28, a frame 17 with a reveal 14, and an exterior lens 16. Overlay panel 52 includes an aperture 13 that is covered by at least a portion of interior lens 18, and frame 17 includes an aperture 15 that is covered by at least a portion of exterior lens 16. The interior lens 18 and the exterior lens 16 may be oval, circular, rectangular, or any other appropriate shape and may be curved or flat. Mechanical shade 28 is typically opaque to block exterior light. The raising and lowering of the shade 28 may occur manually, for example, by pulling a string, or electrically through various techniques known in the art, for example, by a motor.

In particular implementations, Applicant's invention incorporates multiple smart window elements in a modular window assembly such as modular window assembly 10 for improved light control. Depending on the particular configuration, a modular window assembly with multiple light control elements may omit one or more of elements identified in assembly 10. For example, embodiments may be used with or without shade assembly 12 with a mechanical shade 28 or with or without a reveal 52.

In certain embodiments, a modular window assembly may further include a first smart window element and a second smart control window element. For example, the first smart window element may be capable maintaining substantial transparency but allowing variable transmittance, and the second smart window element may be capable of alternating between substantial transparency and substantial translucency. For instance, the first smart window element may be an SPD film, such the SPD technology from Research Frontiers, Inc. of Woodbury, NY, while the second smart window element may be a PDLC film or the “APD-Gray” light valve manufactured by InspecTech Aeroservice, Inc. of Ft. Lauderdale, Fla., as disclosed in published U.S. patent application Ser. No. 12/619,308 (Mattice et al.). The first and/or second smart window elements may be affixed to or incorporated with an interior lens and/or an exterior lens. In these embodiments, a mechanical shade (manually or electrically raised and lowered) may be retained in the modular window assembly and used in combination with the first and second smart window elements.

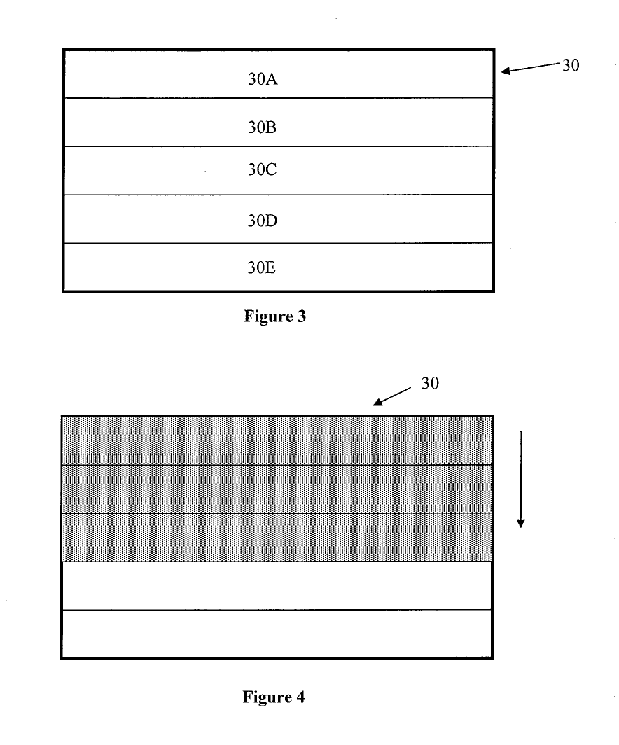

For example, as shown in FIG. 2, a lens 20, such as exterior lens 16, may have two smart window elements sandwiched between inner and outer members. In particular, lens 20 includes an inner member 20A, an outer member 20D, and two center members 20B-C. The inner member 20A and outer member 20D are typically transparent lenses for protection and ease of engagement, and the center members 20B-C are sandwiched between inner member 20A and outer member 20D. The members 20 may, for example, be coupled together through lamination (e.g., by the use of heat and adhesive). An example material for constructing inner member 20A and outer member 20D is Lexan® resin. Other appropriate materials will be known to those skilled in the art. Center member 20B corresponds to one of the first or second smart window elements, and center member 20C corresponds to the other smart window element.

Center members 20B-C each include control lines 22. Control lines 22 may, for example, be electrical lines (e.g., with a positive and a negative). Using control lines 22, a controller (under control of a user, a master controller, etc.) may send control signals to center members 20B-C.

Although FIG. 2 shows the first and second smart window elements incorporated in a lens 20 as center members 20B and 20C, the first and second smart window elements may be placed at other locations. For example, the first and second smart window elements may both be incorporated with an interior lens in the same manner as described above for an exterior lens. In another configuration, one of the smart window elements may be integrated in an exterior lens, while the other may be integrated in an interior lens. Alternatively, one of the smart window elements may be coupled to the interior surface of an exterior lens, and the other smart window element may be coupled to the exterior surface of an interior lens. Additionally, one smart window element may be integrated in a lens, and the other may be coupled to the surface of a lens.

These embodiments of Applicants' novel modular window assembly provide tinting, privacy, and complete light blocking functions.

In other embodiments, a modular aircraft window assembly may include a controllable, segmented smart window element. The segmented smart window element may include multiple smart window segments that may be independently activated and deactivated. The segmented smart window element is typically affixed to or incorporated with a lens or lenses in the window. The constituent segments of the smart window element may be affixed to or incorporated with the same or different lenses.

For example, FIG. 3 illustrates an example segmented smart window element 30 for a generally rectangular, curved window. The segmented smart window element 30 includes five, independently operable smart window segments 30A, 30B, 30C, 30D, and 30E. A controller (not shown, but discussed in further detail below), which may be user-operated, may activate and deactivate the smart window segments. The smart window segments 30A, 30B, 30C, 30D, and 30E are typically the same size and shape, and the smart window segments are usually constructed of the same material (e.g., all SPD segments).

Each smart window segment covers only a portion of the lens or lenses but, when taken together, the smart window segments generally cover the entire lens or lenses. The smart window segments 30A, 30B, 30C, 30D, and 30E may overlap each other to ensure that the entire lens or lenses are covered by the smart window element 30. Portions of the lens or lenses may be concealed behind other components. If some portions of the lens or lenses are obscured, for example, as by overlay panel 52, the smart window segments 30A, 30B, 30C, 30D, and 30E may not need to cover the obscured portions. However, at least partially covering obscured areas with smart window segments may enhance light control effects. In particular implementations, each smart window segment may have contact with at least part of the visible perimeter of the lens or lenses, so that the wires and connections for the smart window segments do not, from a user's perspective, cross the visible surface area of the lens or lenses.

The smart window segments 30A, 30B, 30C, 30D, and 30E may be activated and deactivated in various ways. For example, smart window segments 30A, 30B, 30C, 30D, and 30E may be activated sequentially from top to bottom (and deactivated sequentially from bottom to top) to mimic the lowering (and raising) of a mechanical shade, as illustrated in FIG. 4. In another configuration, the smart window segments 30A, 30B, 30C, 30D, and 30E may be simultaneously activated. The smart window segments 30A-E may also be activated in a variety of other manners (inners to outers, outers to inners, interlaced, etc.). Although FIG. 3 and FIG. 4 describe a smart window element for a rectangular window, similar segment patterns could also be used for oval or circular windows.

The smart window segments 30 may be coupled to the lens by any of a variety of manners. For example, the smart window segments may be applied to the lens by hand. The segments may, for example, be coupled to a lens by lamination (e.g., through the use of adhesive and heat). In other implementations, a smart window element may be coupled to a lens and then cut into the individual segments. For example, a device such as a flat-bed cutter may be used. The control lines may be added after the segments are coupled to the lens. In particular implementations, a second lens may be coupled to the first lens, to form a protective barrier for the segments. The smart window segments 30A-E may be nearly transparent when they are not activated and, thus, not affect the view through the lens (e.g., either in general or by presenting lines where the segments encounter each other).

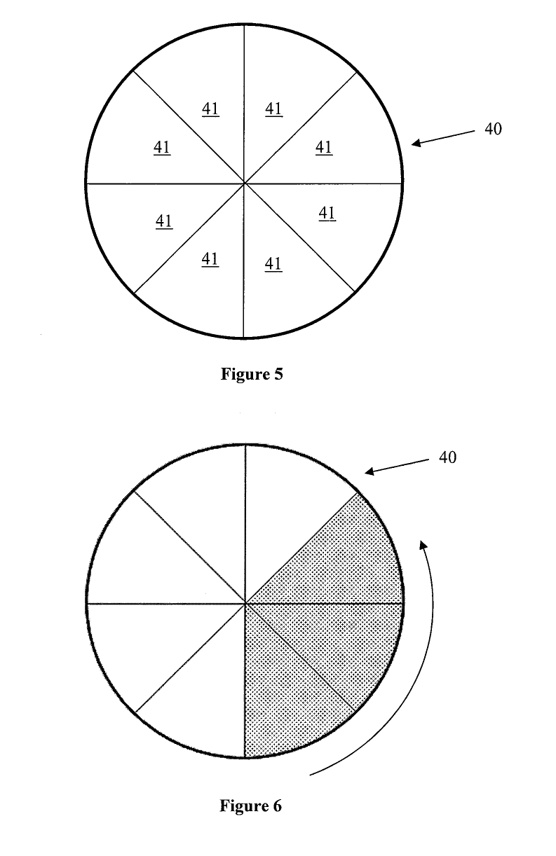

FIG. 5 shows another example segmented smart window element 40 for a circular lens, having a plurality of similarly-dimensioned sectoral smart window segments 41. In addition to simultaneous activation and deactivation of all smart window segments 41, the plurality of smart window segments 41 may be activated or deactivated in a circular manner, as illustrated in FIG. 6. Alternatively, only part of the smart window segments 41 may be activated, leaving the remaining part of the smart window segments 41 deactivated. For example, only the upper half of the smart window segments 41 may be activated. Additionally, in any configuration where the smart window segments 41 are symmetric or mirrored about an axis, as in FIG. 5, the smart window segments may also be activated or deactivated bilaterally in sequential pairs (e.g., left-right, top-bottom, etc.). A variety of other activation sequences exist.

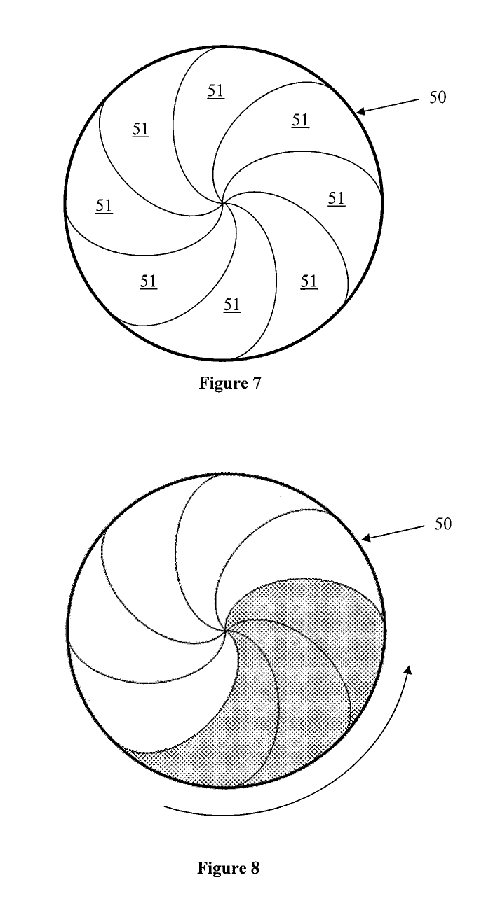

FIG. 7 illustrates another example segmented smart window element 50 for a circular lens. The segmented smart window element 50 has a plurality of curved window segments 51. Each window segment 51 is bounded by a perimeter arc and two elliptical arcs, which meet at or near the center of the window. Circular arcs may also be used in place of elliptical arcs. The plurality of smart window segments 51 may be activated or deactivated in a circular manner, as illustrated in FIG. 8, to mimic an opening and closing. Additionally, the smart window segments may be activated simultaneously, interlaced, or by any other appropriate technique. Although FIG. 5 through FIG. 8 describe a smart window element for a circular window, similar segment patterns could also be used for oval or rectangular windows.

The controller of a window with multiple light control elements, including lens 20, segmented smart window element 30, segmented smart window element 40, and segmented smart window element 50, may be operated by a user, through a cabin management system, automatically through a programmed routine, or by a combination of the foregoing. The controller may allow selection of one of several modes of operation. For example, for segmented smart window element 40, a user may be able to select from the modes of simultaneous activation, sequential activation, or bilateral activation. The controller may also allow activation of the smart window segments using one mode (e.g., downward sequential linear activation) and deactivation of the smart window segments using a different mode (e.g., simultaneous deactivation).

The controller may support user customization via programmed routines. For example, the controller may allow programming the times of activating/deactivating the smart window segments, the modes of operation, and when local user control over the window is permitted. The controller may also incorporate an adjustable speed control for varying the interval between activation/deactivation of the window segments. For example, the adjustable speed control could permit a passenger (or pilot or crew member via a cabin management system) to change the interval between segment activation from 0.5 seconds to 2 seconds. The adjustable speed control may allow a continuously variable interval over a fixed range (e.g., 0.1 to 1 seconds), or the selection of a discrete period (e.g., 0.25, 0.5, or 1 seconds).

When an aircraft uses a plurality of modular windows with light control elements, a master controller (such as one in a cabin management system) may be used to control the plurality of modular windows. The master controller may be capable of overriding local control of the plurality of modular windows and may be programmed to create airplane-wide light control sequences. For example, the master controller could sequentially activate or deactivate light control elements from the front to the back of the aircraft, from the top to the bottom of the aircraft, or on one side or the other.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described below with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

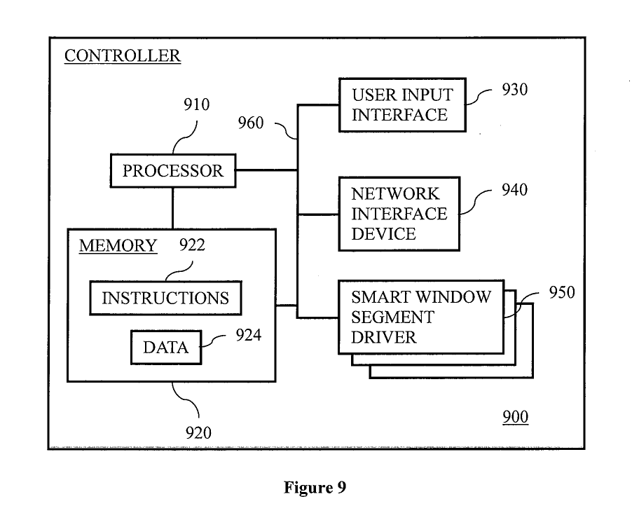

FIG. 9 illustrates selected components of an example controller 900 for a modular aircraft window with multiple light control elements. System 900 may, for example, be used with smart window element 30, smart window element 40, and smart window element 50. Controller 900 includes a processor 910, memory 920, a user input interface 930, a network interface device 940, and a number of smart window segment drivers 950, which are coupled together by a network system 960.

Processor 910 may, for example, be a microprocessor, which could, for instance, operate according to reduced instruction set (RISC) principles or complex instruction set computer (CISC) principles. Processor 910 could also, for example, be a microcontroller. In general, processor 910 may be any device that manipulates information in a logical manner.

Memory 920 includes instructions 922 and data 924. Instructions 922 may, for example, include an operating system (e.g., Windows, Linux, or Unix) and one or more applications, which may be responsible for determining how to control smart window segments in response to input commands. Data 924 includes the data required to control the smart window segment drivers 950 as well as any commands.

User input interface 930 may, for example, receive user input from one or more user input devices (e.g., a keyboard, a keypad, a touchpad, a stylus, a mouse, or a microphone). In general, user input interface 930 may include any combination of devices by which a controller can receive input from a user.

Network interface device 940 may, for example, include one or more communication interfaces. A communication interface may, for instance, be a network interface card (whether wired or wireless) or a modem. In general, network interface device 940 may include any combination of devices by which a computer system can receive and output information over a network (whether wired or wireless).

Smart window segment drivers 950 are responsible for supplying control signals to smart window segments under the control of controller 900. The control signals may, for example, be analog electrical signals (e.g., with a voltage between about 24-28V). In certain implementations, a smart window segment driver 950 may supply control signals for multiple smart window segments.

Network system 960 is responsible for communicating information between processor 910, memory 920, user input interface 930, network interface device 940, and smart window segment drivers 950. Network system 960 may, for example, include a number of different types of busses (e.g., serial and parallel).

Controller 900 may, for example, receive a command to adjust the smart window segments associated with smart window segment drivers 950 through user input interface 930. In response to this command, processor 910 may determine how to control the smart window segments by using instructions 922 and generate commands for one or more of smart window segment drivers 950. For example, if a user has indicated to partially shade a standard aircraft window, processor 910 may determine which smart window segments to activate and send commands to the appropriate ones of smart window segment drivers 950, which may generate appropriate control signals for the associated smart window segments. Controller 900 may also receive a command to adjust the smart window segments associated with smart window segment drivers 950 through network interface device 940 (e.g., from a master controller), and controller 910 may perform a similar determination regarding which smart window segments to activate (or deactivate) and generate commands for the appropriate ones of smart window segment drivers 950.

Although FIG. 9 illustrates a controller for use with a modular aircraft window with smart window segments, a similar controller could be used for a modular aircraft window with multiple smart window elements. For example, the smart window segment drivers could be used for smart window elements.

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modifications and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of embodiments for a modular aircraft window with multiple light control elements have been described, and several others have been mentioned or suggested. Additionally, those of ordinary skill in the art will readily recognize that a variety of additions, deletions, substitutions, and transformations may be made to these embodiments while still achieving a modular aircraft window with multiple light control elements. Thus, the scope of the protected subject matter should be judged based on the following claims, which may encompass one or more aspects of one or more embodiments.

1. A modular aircraft window assembly comprising:
a frame having an aperture;
a substantially transparent exterior lens attached to the frame and covering the opening thereof;
a shade assembly having a substantially opaque, mechanical shade, the shade assembly attached to the frame;
a first smart window element adapted to maintain substantial transparency while allowing variable light transmittance responsive to a first input signal;
a second smart window element adapted to alternate between substantial transparency and substantial translucency responsive to a second input signal; and
a controller for activating and deactivating the first smart window element and the second smart window element;
wherein the controller generates the first input signal and the second input signal.

2. The modular aircraft window assembly of claim 1, wherein the first smart window element and the second smart window element are integrated into the exterior lens.

3. The modular aircraft window assembly of claim 1, further comprising an interior lens.

4. The modular aircraft window assembly of claim 1, wherein the first smart window element is integrated into the exterior lens and the second smart window element is integrated into the exterior lens.

5. The modular aircraft window assembly of claim 1, wherein the first smart window element is coupled to the exterior lens and the second smart window element is coupled to the exterior lens.

6. A light control system for a modular aircraft window assembly, the light control system comprising:
one or more lenses; and
a plurality of separate smart window segments coupled to the one or more lenses, each smart window segment covering a portion of a lens and adapted to vary light transmittance responsive to an input signal.

7. The light control system of claim 6, further comprising a controller coupled to the plurality of smart window segments, the controller adapted to adjust the smart window segments.

8. The light control system of claim 7, wherein adjusting the smart window segment comprises activating and deactivating the smart window segments.

9. The light control system of claim 7, wherein the controller generates a plurality of control signals, each control signal for controlling one smart window segment.

10. The light control system of claim 7, wherein the controller adjusts the plurality of smart window segments according to a predetermined, preprogrammed pattern.

11. The light control system of claim 10, wherein the predetermined, preprogrammed pattern simulates the opening and closing of a physical shade.

12. The light control system of claim 6, wherein the smart window segments are coupled to a surface of a lens.

13. The light control system of claim 6, wherein the smart window segments are integrated into a lens.

14. The light control system of claim 6, further comprising a frame that holds a lens, the frame having an aperture that at least a portion of the lens covers and through which light may encounter the lens, wherein the smart window segments cover substantially all of the lens inside the aperture.
